(19) United States
(12) Patent Application Publication
(10) Pub. No.: US 2026/0264185 A1
(43) Pub. Date: Sep. 10, 2026

(54) APPARATUS FOR COLLECTING SCRAP FROM A MACHINE TOOL

(71) Applicant: S.I.A. S.R.L., Bologna (BO) (IT)

(72) Inventor: Alberto CANTALU, Castelnuovo Rangone (IT)

(21) Appl. No.: 18/867,879

(22) PCT Filed: May 25, 2023
(86) PCT No.: PCT/IT2023/000018

§ 371 Date: Nov. 21, 2024

(30) Foreign Application Priority Data
May 30, 2022 (IT) 102022000011315

(51) Int. Cl. B23Q 11/00

(52) U.S. Cl. CPC B23Q 11/0075

(57) ABSTRACT

An accumulation system for mechanical pieces coming out of a machine tool comprises a container (10) and a disk (20). The container (10) comprises a bottom wall (11) and a side wail (12). The disk (20) is positioned within said container (10) with its own vertical axis (Y_20) lying coaxial with respect to the vertical axis (Y_10) of the container (10) and the disk (20) has an external diameter (20_D1) having an amplitude smaller than the internal diameter (12_D1) defined by the wall (12) of the container (10), in order to form an opening (14) having a given radial width )D_14). The disc (20) is rotated with respect to its own vertical axis (20_Y) and with respect to the container (10).

### FIELD OF INVENTION

The present invention refers to the sector of accessories for machine tools.

More particularly, the present invention relates to the field of industrial automation systems, in order, for example, to implement and/or increase and/or improve operational autonomy in the execution of unmanned mechanical processes, such as, again for example, in the execution of mechanical processes carried out using bar lathes.

Again the present invention also refers to other processes and/or systems and/or automatic and/or semi-automatic production machinery for carrying out mechanical processes.

### BACKGROUND OF THE INVENTION

At the present containers or baskets are known for collecting and accumulating the workpieces machined at the outlet of a machine tool, in which said pieces are accumulated on a horizontal accumulation plane or inserted into cavities formed by support grids.

Turning plate systems are also currently known on the basis of the prior documents CH.0.379.884 and DE.0.569.053.

Said known containers or baskets or systems include a series of drawbacks.

A first drawback is due to the fact that they do not allow to operate safely and autonomously in industrial automation systems.

A second drawback is due to the fact that they do not allow the storage surface to be kept clean.

A third drawback is due to the fact that they do not allow to adapt easily and quickly with respect to different types of machines and/or machine tools having, for example, the outlet mouth of the machined piece outlet chute positioned at different heights with respect to the ground.

A fourth drawback is due to the fact that they do not allow to implement and/or operate and/or interact in an “Industry_4.0” type production plant.

A fifth drawback is due to the fact that they do not allow the machined pieces to be accumulated on an accumulation plane and, furthermore, to accumulate them avoiding collisions between them which could cause damage to them.

### Exhibition of the Invention

The object of the present invention is therefore to solve the aforementioned drawbacks.

The invention, which is characterized by the claims, solves the problem of creating an accumulation system for mechanical pieces coming out of a machine tool, in which said system extends along a respective vertical axis; wherein said system extends along a respective transverse axis; wherein said system is characterized by the fact that it comprises: a container, having the shape of a circular cup, in which said container extends axially along its own vertical axis; and a disc, having the shape of a circular plate, which extends axially along its own vertical axis; by the fact that said container comprises a bottom wall and a vertical side wall; by the fact that said disc comprises an upper accumulation surface and a circumferential perimeter; by the fact that said disc is positioned into said container with its vertical axis lying coaxial with respect to the vertical axis of the container; by the fact that said disc has an outer diameter having a smaller width than the inner diameter defined by the annuler wall of the container, in order to form, between said outer diameter and said inner diameter, a drop opening having the shape of a crown circular and having a certain radial width; by the fact that said disc is driven to rotate with respect to its own vertical axis and with respect to the container

### BRIEF DESCRIPTION OF THE DRAWINGS

Further characteristics and advantages of the present invention will be more evident from the following description of some of its preferred practical embodiments, given here by way of purely non-limiting example, made with reference to the figures of the attached drawings in which:

FIG. 1 shows a perspective view of the system object of the present invention;

FIG. 2 illustrates the system object of the present invention as a sectional view with respect to a central vertical plane;

FIG. 3 shows in enlarged form a first portion of FIG. 2;

FIG. 3A illustrates a variant embodiment with respect to FIG. 3;

FIG. 4 illustrates in enlarged form a second portion of FIG. 2;

FIG. 5 and 5A illustrate a detail of the invention.

Preferred Example of Non-Limiting Form of Practical Implementation

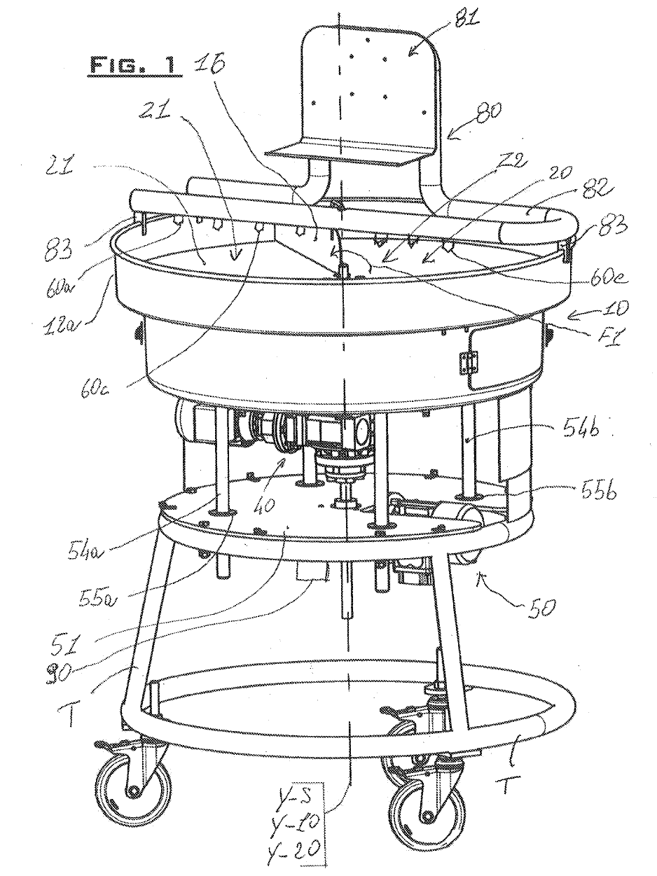

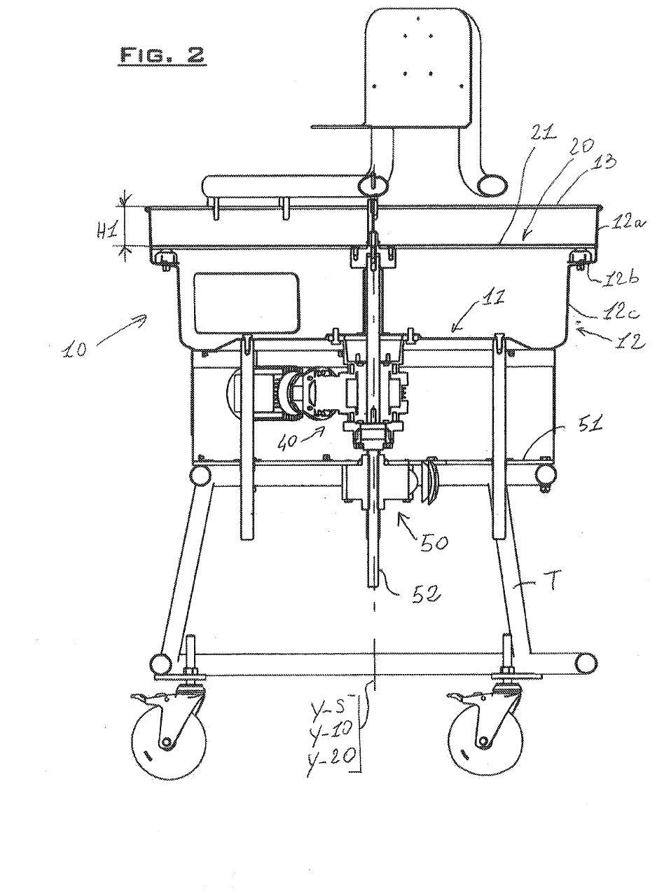

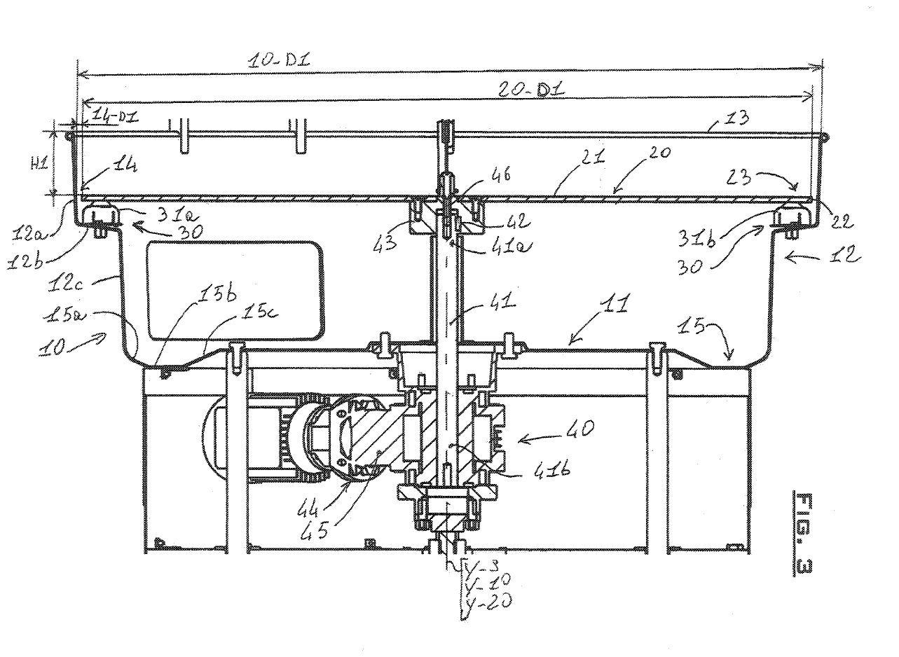

With particular reference to FIGS. 1, 2 and 3, the accumulation system for mechanical pieces coming out of a machine tool, object of the present invention, extends along a respective vertical axis Y_S and along a respective transversal axis X.

Still with reference to said figures, essentially, said system comprises a container 10 and a disk 20.

The container 10 has the shape of a circular cup and extends axially along its own vertical axis Y_10 and transversely along a transversal axis X.

The disk 20 has the shape of a circular plate and extends axially along its own vertical axis Y_20 and transversely along a transversal axis X.

The container 10 comprises a bottom 11 or bottom wall 11, better described below, and a vertical side wall 12 or side wall 12, having the shape of a circular ring, also better described below, having an edge upper extremity 13.

The disc 20 essentially comprises an upper accumulation surface 21, on which the machined pieces will be deposited and accumulated, and a perimeter or circumferential radial end 22.

In the system object of the present invention, the disc 20 is positioned within said container 10, with its vertical axis Y_20 lying coaxial with respect to the vertical axis Y_10 of the container 10, as well as positioned with its radial end 22 positioned at a given axial distance vertical H1 with respect to the axial end of the upper edge 13 of the container 10, in order to form an accumulation compartment for the machined pieces, in which said compartment is defined by the upper surface 21 of the disc 20 and by the side 12-12a of the container 10, in which said compartment has a vertical height H1

The disc 20 has an external diameter 20_D1, having a smaller width than the internal diameter 10_D1 defined by the internal profile of the wall 12 of the container 10, in the particular case illustrated smaller than the internal diameter 10_D1 defined by a portion 12a of the upper wall 12a, in which said wall 12a is positioned and extends radially spaced apart 14_D1 in the vicinity of the circular radial end profile 22 defined by the disc 20, in order to form, with reference to said external diameter 20_D1 and to said internal diameter 10_D1, a drop opening 14 (a light), having the shape of a circular crown and having a given radial width 14_01.

During operation, as will be understood below, through said circumferential opening 14, liquids and/or swarf/shavings and/or other undesirable similar elements, which can reach the plate 10 together with the worked pieces, can freely pass through said opening 14 and, therefore, fall downwards (preferably until it reaches the bottom 11 of the container 10) and, in this context, preferably, said opening 14 has a radial width 14_D1 smaller than the minimum size of the machined pieces to be accumulated, in order to obviate that said pieces can pass through said opening 14 or fit into said opening 14 and, at the same time, in order to allow the free passage of liquids, swarf/shavings and other similar elements having smaller dimensions than those of the machined pieces.

With reference to the description described above, during use, the disc 10 is rotated (in a continuously manner or in a programmed manner or in a other manner) with respect to its vertical axis 20_Y and with respect to the container 10, such as, for example, in counter clockwise rotation, as arrow F1 of FIG. 1, while the container 20 remains stationary (not rotating), so that the worked pieces, for example a worked piece positioned (manually or by falling) in the area Z1, by means of a chute and/or hopper and/or other similar device, will be, by friction, transported and pushed by the upper surface 21 of the plate 20, first towards and against a fixed limit stop pallet 16 and, subsequently, the pieces are accumulated one against the other, and in this manner accumulated on the plate 20.

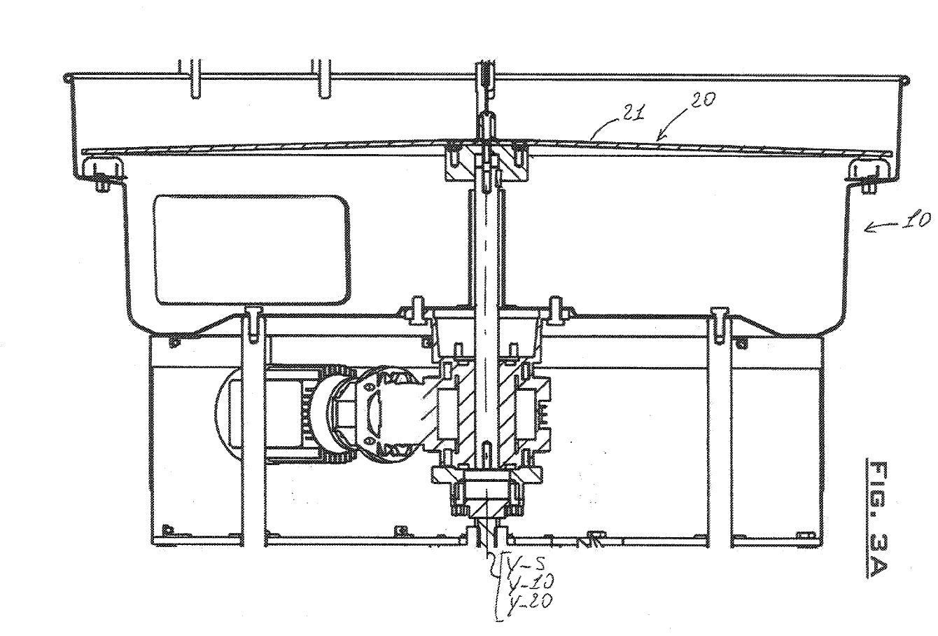

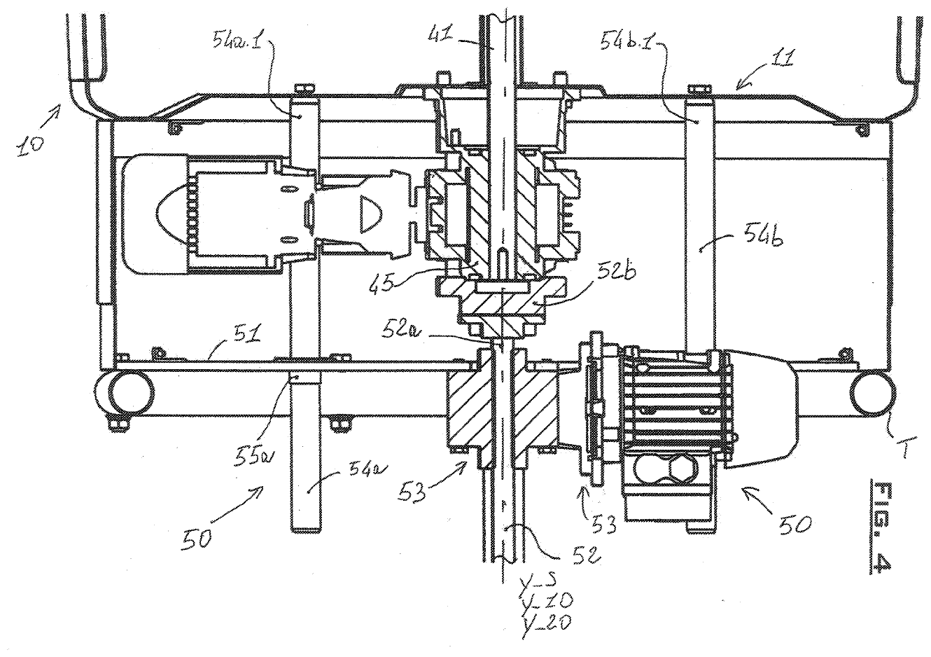

With reference to the above specification, according to a preferred embodiment, see FIG. 3A, said disc 20 has an upper accumulation surface 21 which, from the center 20_Y towards the perimeter 23, configures a surface inclined from top to bottom, which, with respect to a vertical section, can configure a straight and/or curvilinear (as in FIG. 3A) profile and/or of another type, such as for example an upper surface having the shape of a dome (as in FIG. 3A) or in the form of a cone, or in the form of a “roof” inclined from top to bottom from the center towards the end 22.

FIG. 3A shows an upper surface 21 having the shape of a dome, but it is specified that other embodiments intended to perform the same function are protected by the present invention.

With reference to the above specification, according to a further preferred embodiment, see FIG. 3, said disc 20 has a completely flat upper accumulation surface 21, ie a flat and coplanar surface 21.

With reference to FIG. 3, the bottom 11 or bottom wall 11 of the container 10 preferably comprises a collection (drain) channel 15, which extends circumferentially on the bottom 11 in the form of a closed ring channel, which preferably has a cross section in the shape of a “V” with a flat bottom, formed, for example, by means of an inclined wall 15a, a wall with a horizontal bottom 15b and a side wall 15c formed by the same container 10, in which said channel 15 is able to collect and channeling the liquids that will be collected within said container 10, as well as collect fragments of swarf/shavings and other elements that have passed through the above mentioned opening 14.

Said channel 15 could also include at the bottom a filter (not shown) for the swarf/shavings positioned upstream of a discharge neck (not shown) for liquids outlet, in which this neck can be connected by means of a pipe to a hydraulic pump, in order to withdraw the liquids collected in the channel 15 and transfer said liquid where desired.

Still with reference to FIG. 3, the disk 20 is supported axially in a rotating manner with respect to its axis Y_20 and with respect to the container 10 by means of first support means 30, in which, preferably, said support means 30 are fixed to and supported by the container 10, in such a way that the axial load of said disk 20 and of the pieces lying on said disk 20 will be supported by said support means 30 and, therefore, by the first container 10.

In this context, as a preferred non-limiting practical embodiment, the first support means 30 can comprise a plurality of ball supports 31a, 31b, etc. (so-called ball transfer units), having their socket (or flange) fixed to the container 10, i.e. supported by the container 10 and, preferably, arranged circumferentially equidistant, which are able to engage and support in a sliding manner the lower face of the peripheral edge 23 of disc 20.

In this context, preferably, the container 10 comprises a circumferential support portion 12b for fixing said support means 30, in which said support portion 12b has a flat shape which defines a circular crown, in which on said portion 12b is preferably slightly inclined radially from the outside to the inside from top to bottom, in order to determine the flow of any liquids and other elements that passing through the opening 14 have fallen into the container 10

Still with reference to FIG. 3, said disc 20 is rotated with respect to its own axis 20_Y and with respect to the container 10 by means of a transmission unit 40, in which said transmission unit 40 is preferably fixed to and supported by said container 10, as for example constrained against the lower face of the bottom wall 11 of the container 10, in order to transmit the rotary motion to the disk 20 by means of a vertical transmission shaft 41 which is mounted passing axially through said bottom wall 11 of the container 10 and positioned coaxially with respect to the axis Y_10 of the container 10 and to the axis Y_20 of the disk 20.

Always with reference to FIG. 3, substantially, the transmission unit 40 comprises said transmission shaft 41, passing axially and rotatably free through the bottom wall 11 of the first container 10, in which said transmission shaft 41 has an upper portion thereof, 41a, connected to the disk 20 by means of a key 42 and a flange 43 fixed to the same disk 20, and a lower portion thereof, 41b, extending downwards, beyond the bottom wall 11 of said container 10, in which said lower portion 41b is connected to first actuator means 44, which can be of various types, in which said first actuator means 44 are able to rotate said transmission shaft 41.

The first actuator means 44 are fixed to said container 10, as for example fixed against the lower face of the wall 11 by means of a fixing unit 45 comprising elements and fixing means, in order to support said first actuator means 44 in a constrained and pendant manner.

Moreover, preferably, fastening means 46 are also provided, such as for example a screw 46, which has a head lying against the bottom part 11 and the shank coupled axially with the upper portion 41a of the shaft 41, in order to prevent said shaft 41 from falling downwards, as well as from remaining fixed axially to the disk 20

### Means 50 for Lifting/Lowering/Positioning Axially

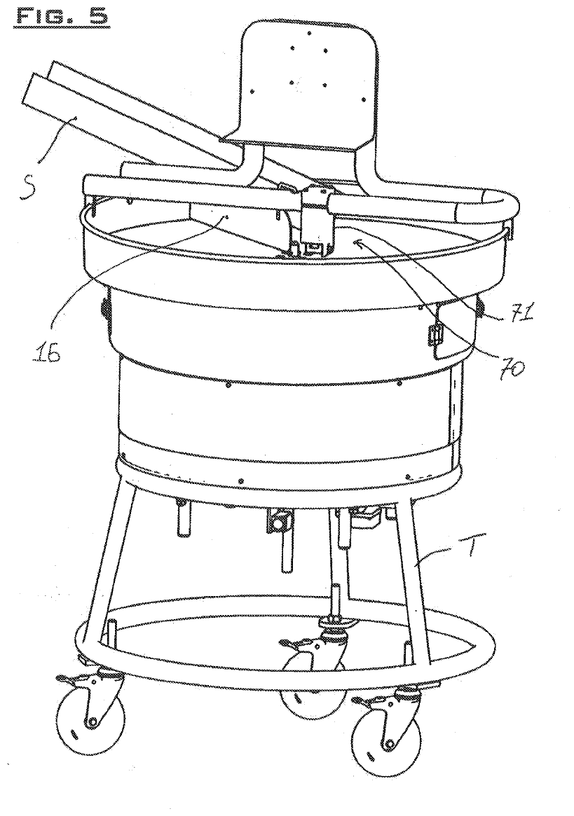

With reference to FIGS. 1 and 4, the system object of the present invention can further comprise lifting and/or lowering and/or axial positioning means 50, which are suitable for lifting or lowering or for axially positioning the container 10 with respect to S an underlying support frame T, i.e., in the illustrated embodiment, able to move and position axially and in unison the assembled and self-supporting group as described above, comprising the container 10, the disc 20, the support means 30 and the transmission unit 40.

With particular reference to FIG. 4, said lifting and/or lowering and/or axial positioning means 50 substantially comprise a support plate 51, a support and axial movable column 52, linear actuator means 53, a plurality of vertical axial pins 54a, 54b, etc., which can move axially in a centred manner, and a plurality of axial bushings 55a, 55b, etc., for axial sliding of these pins.

The support plate 51 is supported in an axially spaced manner with respect to the ground by means of a frame T and, always said support plate 51, supports the linear actuator means 53 in a fixed manner The linear actuator means 53 can be of various types, mechanical, hydraulic, electromechanical, electric, etc. and, substantially, are able to lift/lower/position, axially Y, said support and movable column 52, which is preferably positioned with its axis Y_52 lying coaxial with respect to the axis Y_10 of the container 10.

The support column 52 has its upper portion 52a equipped with a thrust flange 52b, which abuts the lower face of the fastening unit 45 which in turn abuts the bottom wall 11 of the container 10.

With reference to the plurality of pins 54a, 54b, etc. they have their top 54a.1, 54b1 fixed to the bottom part 11 of the container 10 and their stem mating in a free and axially sliding manner (preferably with minimal play) with the bushings 55a, 55b, etc., in which these latter are fixed on this plate 51.

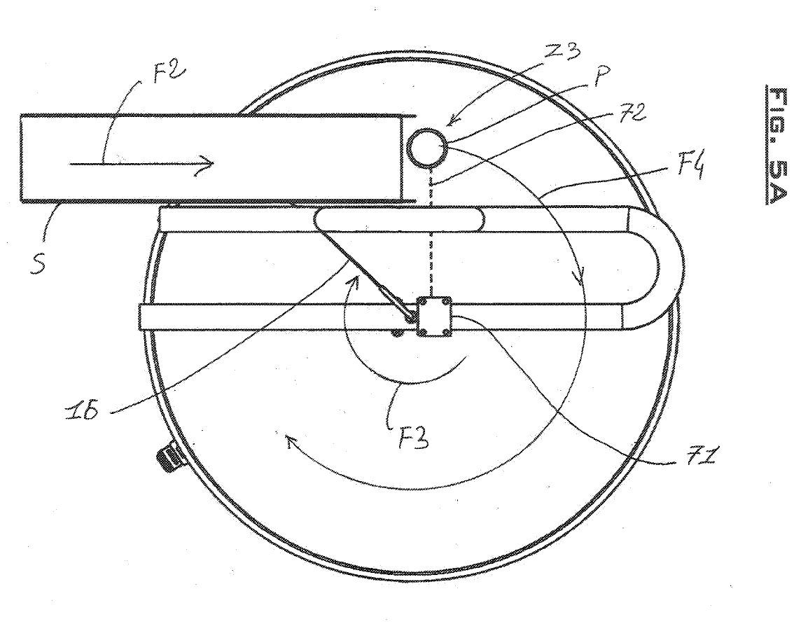

By means of these lifting and/or lowering and/or axial positioning means 50, by activating the actuator means 53, the support column 52 can be axially moved and axially positioned, with consequent lifting and/or lowering and/or positioning of the aforementioned assembled and self-supporting group, which comprises the container 10, the disc 20, the support means 30 and the transmission unit 40 and, therefore, the receiving surface 21 of the disc 20 can be positioned at a desired height which will be selected in relation to the height of the outlet of an outlet hopper or outlet chute S (see FIG. 5) or other similar device, of any machine tool.

### Nozzles Ejector Means 60

With reference to FIG. 1. the system object of the present invention can further comprise nozzles 60a, 60b, etc, which can be of various types, suitable for ejecting air and/or liquids and/or other substances onto the upper surface 21 of the disc 20, in order, for example, to keep said upper surface 21 clean from any shavings/swarf. which could reach the same surface 21 as they have undesirably fallen and/or collected from the feeding hopper (or chute S see FIG. 5) which unloads the pieces worked on disc 20.

The said nozzles 60a, 60b, etc., which can be of various types, can be able to perform various and/or different types of operations (ejections) and, furthermore, they can be positioned and/or oriented in different ways, as better understood in hereinafter, and always said nozzles will preferably be connected to conduits for transporting (feeding) the fluid, conduits not shown, upstream of which a fluid pumping/inlet apparatus, also not shown, will be provided preferably.

More particularly and preferably, said nozzles 60a, 60b, etc, can be able to eject puffs of air, towards and/or against the upper surface 21 of the disc 20, in which said puffs preferably have an orientation having a direction oriented from top to bottom and from the center 20 Y of the disc 20 towards the outside 22 of the same disc 20, wherein said blows can be of the continuous and/or intermittent type, as well as of the automatic and/or programmed and/or controlled type.

Still preferably and/or if desirable, said nozzles 60a, 60b, etc., can also be able to eject liquid (e.g. like a shower) and/or air and liquid and/or other desired substance, always towards and/or against and/or on the upper surface 21 of the disc 20, acting in a similar manner with respect to that described above in relation to the air blows.

### Sensor Means 70

With reference to FIG. 5 and SA, the system object of the present invention can further comprise sensor means 70, which, summarily, are suitable for detecting the presence and/or non-presence of at least one machined workpiece P in a given area Z3 of the compartment 20_12a for storing the machined pieces, as well as capable of sending signals in relation to the detections performed, in order to be able to implement different controls and/or different procedures, preferably with the aid of one or more control units which can be of various types, in which said control units can be positioned in the system object of the present invention or elsewhere.

By way of non-limiting example, said sensor means 70 can transmit the signals relating to the detections to a control unit (e.g. control unit 90 in FIG. 1) present in the system object of the present invention which controls at least the first actuator means 44 and/or to an external central control unit (e.g. control unit 90 in FIG. 1) which controls both the system object of the present invention (therefore always at least the first actuator means 44) as well as the machine tool located upstream of the system object of the invention present invention, machine tool from which the machined pieces come (as better understood hereinafter), or transmitting said signals to other control means which may be present in the processing plant, in which said plant is intended to operate using the system object of the present invention.

In this context, with reference to the cited FIGS. 5 and 5A, by way of example, the system object of the present invention can further comprise a chute S (or analogous means, such as, for example, a transport belt conveyor), along which, with reference to the arrow F2, the worked pieces, coming from a machine tool (not shown), positioned upstream of said chute S, are conveyed, arrow F2, towards and above the plate 20, in order to deposit them, by falling, initially in an area Z3, located downstream of said slide S.

As above described, the area Z3 is monitored by said sensor means 70, which, mainly without limiting intentions, comprise at least one sensor 71, which can be of various types, optical, pneumatic, electronic, electrotechnical, etc., in any case capable of detect the presence or absence of a machined piece P in said area Z3.

In the embodiment illustrated, by way of example, said sensor means 70 comprise a sensor 71 of the optical proximity sensor type, which comprises a transmitter and a receiver, in which said sensor 71 projects an optical beam 72, in which said sensor 71 is connected to control (and/or processing) means to which it transmits the relative detection signals as previously described.

In this context it is specified that the use of other types of sensors able to perform the same detection function are protected by the present invention.

Preferably, by way of example, the sensor 71 can detect the fall of the piece P and/or the arrival of the piece P in the Zone 23 located downstream of the chute S and, once the descent and/or the presence of the piece P in said zone Z3 has been detected, the sensor means 70 transmit a relative signal (an input) to a control unit (e.g. control unit 90 in FIG. 1), which activates the rotation of the disk 20 with direction F3, i.e, it activates the first actuator means 44, in order to push and if it is possible to transport the objects present on the disc 20 against the stop pallet 16, see arrow F4.

Through this rotation of the disk 20, a force F4 is applied to the piece P by friction in order to translate said piece P towards and against the pallet 16, in which, starting from an empty space, the pieces will accumulate over time against each other and, then:
A) if after activation of the rotation of the disk 20, downstream of the zone Z3 with respect to the arrow F4, there are no previously accumulated pieces which hindered the translation of the piece P out of the zone Z3, this piece P. lying on the disk 20 in zone Z3 can move freely outside said zone Z3; while,
B) if after the activation of the rotation of the disk 20, downstream of the zone Z3 with respect to the arrow F4, there are previously accumulated pieces which, despite the rotation of the disk 20, continue to occupy or to lap this zone Z3, these pieces already present form a vertical abutment and prevent piece P from moving freely out of said zone Z3 and, therefore, piece P cannot get out of zone Z3.

In this context, for example, a control can be set in which it is expected that if the translation of the piece P outside the zone 23 (area under the control of the sensor means 70—sensor 71) should not take place within a pre-set time frame, as for example within 10 seconds from the start of the rotation of the disc 20 (or within 10 seconds from the beginning of the detection performed by detection means 70 sensor 71 of the piece P in the zone Z3), the sensors means 70 send a signal (message) of full compartment to the control system and/or to the control of the plant connected to the system, for example to proceed for a stop of the production of the relevant machine tool, in order to stop the feeding of the machined pieces in the compartment 20_12a of the system, which is already full, in order to avoid damage due to uncontrolled accumulation of the pieces.

Again by way of example, if desirable, it is also possible to set a rotation for the disk 20 with continuous motion (and not with commanded motion) and, if the zone Z3 is occupied by at least one piece for a period of time longer than, for example, 10 seconds, the sensor means 70 send a full compartment signal (message) to the control of the system and/or to the control of the plant connected to the system, to then proceed as described above.

With reference to what has been described above, if desirable, the sensor means 70 can further be used to emit an acoustic or light signal for the operator, i.e. to emit a signal to communicate that the collection compartment pieces is full and needs to be emptied.

With reference to the above description, if desirable, the sensor means 70 can further be used to prevent that a machined piece from being deposited (dropped) in said area Z3 if the presence of a machined piece is detected in the same area Z3 (as for example if the previously dispensed piece is still present), in order to proceed with the deposit and/or drop of a worked piece in zone Z3 only if this zone Z3 is free (not occupied) by other pieces and, in this way, avoid a collision between the piece being dispensed/falling and the pieces present, in order to prevent damage to the same pieces.

Still with reference to the above description, if desirable, the sensor means 70 can further be used to avoid to deposit (dropping) a machined piece in said area 23 if the presence of a machined piece is detected in the same area Z3 (as for example if the previously dispensed piece is still present), in order to proceed with the deposit and/or drop of a worked piece in zone 23 only if this zone Z3 is free (not occupied) by other pieces and, in this way, avoid a collision between the piece being dispensed/falling and the pieces present, in order to prevent damage to the same pieces.

Again by way of example, if desirable, it is also possible to set a rotation for the disc 20 with continuous motion and/or with intermittent motion (and not with controlled motion as mentioned above) and, also in this case, if the zone Z3 is occupied by at least one piece for a period of time longer than for example 10 seconds, the sensor means 70 send a signal (message) of full compartment to the control of the system and/or to the control of the plant connected to the system, in order to be able to proceed as above mentioned.

### Suspended Support Means 80

With reference to FIG. 1, the system object of the present invention can further comprise suspended support means 80 on the top.

Preferably said support means 80 comprise a support/work element 81, a support frame 82, and fastening elements 83.

The support element 81 can have various embodiments selected in relation to the function that it will have to perform, such as, for example, a lectern-like shape to be able to accommodate sheets (drawings) and/or measuring instruments and/or a computer and/or other device,

The support frame 82 is preferably made of tubular elements is able to form a through duct, in order to be able to contain, for example, transmission and/or power supply cables for a CPU.

The fastening elements 83 are preferably elements which can be coupled in a removable manner with the upper edge 13 of the container 10, in order to be able to remove/apply said support means 80 in a simple and rapid manner.

### Control Unit 90 and/or Other Control Units

With reference to FIG. 1 and as mentioned above, the system object of the present invention can further comprise at least a first control unit 90, which can be able to control one or more operating members of the system object of the present invention, such as, for example: the first actuator means 44; the lifting/lowering/axial positioning means 50; the ejector nozzle means 60 and relative members upstream thereof; the sensor means 70; other operational devices if they are present.

Furthermore, if desirable, this first control unit 90 can also be able to connect the system object of the present invention with the control system of a related production plant, in order, for example, to implement a production plant of the type “Industry_4.0”.

As an alternative, this last feature can also be implemented by means of a further (second) and different and separate control unit, not illustrated, positioned in the system object of the present invention and/or another place of the plant, without departing from the inventive concepts protected by the present invention.

By means of the system object of the present invention the above problems are solved.

The description of the system as indicated above is given as a purely non-limiting example and, therefore, it is evident that all those modifications or variations suggested by practice and by its use can be made to said system and, in any case, within the scope of scope of the following claims, which also form an integrative part for the present description.

1. An apparatus for collecting mechanical scrap coming out from a machine tool, the apparatus comprising:
an upwardly open cup-shaped container centered on a respective vertical container axis;
a circular plate-shaped disk centered on a respective vertical disk axis, the container having a bottom wall, a vertical side wall, an accumulation surface, and a circumferential perimeter, the disk being within container with the vertical disk axis coaxial with the vertical container axis, the disk further having an external diameter smaller than an inner diameter defined by an inner surface of the side wall of the container in order to form between the circumferential perimeter and the inner surface an annular opening having a predetermined radial width smaller than a minimum size of the scrap being collected, the radial width being such as to prevent the scrap being collected from passing through the annular opening, the radial width being such as to allow the free passage of liquids and/or shavings and/or other similar elements having smaller dimensions than those of the scrap to be collected; and
means for rotating the disk about the vertical disk axis with respect to the container.

2. The apparatus according to claim 1, wherein the disk has an upper surface of accumulation having a shape inclined from a disk center toward the perimeter from top to bottom.

3. The apparatus according to claim 1, wherein the disk has an upper surface of accumulation having a dome-like shape.

4. The apparatus System according to claim 1, wherein the disk has a downwardly upper surface of accumulation having a shape in the form of a frustocone.

5. The apparatus according to claim 1, wherein the disk has an upper surface of accumulation having a planar shape.

6. The apparatus according to claim 1, wherein the bottom wall of the container is formed with a drainage channel.

7. The apparatus according to claim 1, wherein the disk is supported axially in a rotating manner with respect to the vertical disk axis and with respect to the container by first support means fixed to the container.

8. The apparatus according to claim 7, wherein said the first support means comprise a plurality of ball transfer units fixed to the container and abutting and to supporting in a freely sliding manner with the balls at the perimeter of the disk.

9. The apparatus according to claim 1, wherein the means for rotating includes a transmission unit fixed to the container.

10. The apparatus according to claim 1, wherein the means for rotating includes a transmission unit having a transmission shaft axially and rotatably passing through the bottom wall of the container and having an upper portion connected to the disk and a lower portion extending downward beyond the bottom wall of the container. the lower portion being engaged with first actuator means able to rotate the transmission shaft and fixed to the container.

11. The apparatus according to claim 1, further comprising an axial lifting and/or axial lowering and/or axial positioning assembly (for axially lifting and/or axially lowering and/or axially positioning the container with respect to an underlying support frame.

12. The apparatus according to claim 1, further comprising:
a support plate;
a support column;
linear actuator means;
a plurality of vertical sliding pins;
a plurality of bushings, wherein
the support plate fixedly supports the linear actuator means that axially supports and, axially moves and axially positions the support column that has an upper portion axially connected with the bottom wall of the container,
the plurality of pins have their upper ends fixed to the bottom wall of the container and are coupled in an axially sliding manner with respective bushes.

13. The apparatus according to claim 1, further comprising:
nozzles able to eject air and/or liquids and/or other substances on the upper surface of the disk.

14. The apparatus according to claim 1, further comprising:
sensor means for detecting the presence and/or non-presence of at least one machined piece in a determined area of the storage compartment for the machined products.

15. The apparatus according to claim 1, further comprising:
sensor means for detecting the presence and/or non-presence of scrap in a determined area of the storage compartment for machined products; and control unit for ensuring that a machined piece is not deposited in this area if a machined piece is detected in the same area.

16. The apparatus according to claim 1 further comprising:
at least one control unit for controlling at least one of the operating members of the apparatus.

17. The apparatus according to claim 1, further comprising:
at least one control unit for connecting the apparatus with a control system of a relative production plant.

18. The apparatus according to claim 1, further comprising:
support means on the top of the apparatus.

19. (canceled)
